(19) United States
(12) Patent Application Publication
(10) Pub. No.: US 2001/0000911 A1
(43) Pub. Date: May 10, 2001

(54) Reduction of HF

(76) Inventors: Harry E. Stewart, Ft. Pierce, FL (US); Donald B. MacElwee, Wayne, PA (US)

Correspondence Address: Ronald R. Santucci, Pitney, Hardin, Kipp & Szuch, LLP, 711 Third Avenue, 20th Flor, New York, NY, 10017, US

(21) Appl. No.: 09/756,256

(22) Filed: Jan. 8, 2001

Related U.S. Application Data
(63) Continuation of application No. 09/427,891, filed on Oct. 26, 1999.

(51) Int. Cl. A62D 1/02

(52) U.S. Cl. 252/7

(57) ABSTRACT

The invention comprises a substantially non-aqueous, flame-extinguishing composition for extinguishing a fire at the sight of a potential flame comprising a fluorocarbon in admixture with a gelled powder additive comprising salts of weak acids which decompose at the temperature of the sight to reduce or eliminate HF released by the composition when used to extinguish flames.

### BACKGROUND OF THE INVENTION

1. 1. Field of the Invention

2. The invention relates to a composition to control, reduce or eliminated Hydrogen Fluoride (HF).

3. 2. Brief Description of the Related Art

4. The literature is replete with descriptions of fire-extinguishing compositions. Included in such compositions are gelled compositions comprising dry solid chemicals for extinguishing flames and inhibiting oxidation (for example sodium and potassium bicarbonate) and vaporizing organic liquids like brominated hydrocarbons. The latter compounds also extinguish flames very effectively. The mechanism by which brominated hydrocarbons extinguish flames is two-fold. The primary mechanism involves the termination of free radical ion reactions that sustain combustion and a secondary mechanism is heat abstraction associated with a high vapor heat capacity and a high heat of vaporization.

5. A number of perfluorocarbons, chlorofluoro-carbons (CFC) and hydrofluorocarbons (HFC) by themselves have been identified as potentially useful to extinguish fires in flooding applications, and being free of bromine content or low in chlorine content, have little or no ozone depletion potential (ODP). Representative of these perfluorocarbons, chlorofluorocarbons and hydrofluorocarbons are 2-chloro-1,1,1,2-tetrafluoroethane, pentafluoroethane, 1,1,2,2-tetrafluoroethane, 1,1,1,2-tetrafluoro-ethane, 1,1,1-trifluoroethane, perfluorocyclopropane, perfluoropropane, perfluorocyclobutane and the like; see U.S. Pat. No. 5,135,054, which is incorporated herein by reference thereto. The chlorofluorocarbon compounds are also referred to by the “CFC” system of nomenclature, and the hydrofluorocarbons by the “HFC” system. Under these systems, the first digit represents the number of carbon atoms minus one (and is omitted if zero); the second digit represents the number of hydrogen atoms plus one; and the third digit represents the number of fluorine atoms, For example, HFC-125 represents pentafluoroethane.

6. In U.S. Pat. No. 5,833,874, we disclosed fire-extinguishing compositions of low ozone depletion potential comprise dry particles of fire-extinguishing agents dispersed in a gel of liquified volatile perfluorocarbons, chlorofluorocarbons or hydrofluorocarbons. The dry particles are compatibilized with the carrier gel by the presence of a surfactant system composed of a non-ionic surfactant, a film forming fluorocarbon surfactant and a phosphorus containing antiflocculent. The compositions of the patent are hybrids, i.e., gelled formulations of dry powder agents delivered in liquified hydrofluorocarbons and chlorofluorocarbons.

7. Extinguishing open flames within a confined space such as a room in a building, an engine compartment in a vehicle, aircraft interiors, enclosed fuel storage areas, electric control boxes, storage containers, hazardous material storage facilities and the like has always posed problems of speed in extinguishing and clean-up requirements after the flame is extinguished. The first problem is related to placement of a fire extinguishing composition at the flame site, in sufficient quantity to extinguish a flame rapidly and on demand. The second problem is related to the nature of the fire extinguisher composition and its residues after flame extinction.

8. Normally the HFC, PFC and HCFC gases that are developed to replace Halons generate unacceptable high quantities of Hydrogen Fluoride when putting out fires, thereby running the risk of killing the persons in the “occupied” space from which the fire emanated even when the fire is put out. There are no HFC or PFC or HCFC gases that are exceptions to this statement. This covers the list of gases that are now EPA permitted to be used for fire extinguishment.

9. Thus there is a need for gaseous Halon replacements that have demonstrated a greater affinity for HF production in fire scenarios.

10. There is also a need for gas based extinguishants for automatic fire extinguishers for moving vehicles, planes, ships, and electronics which are enclosed or semi-enclosed and thus need the elimination of HF to occur relatively rapidly.

### SUMMARY OF THE INVENTION

11. It is therefore a principal object of the invention to overcome the shortcomings of the prior art heretofore mentioned.

12. It is a further object of the invention to provide a method for reducing HF to EPA accepted levels.

13. We have discovered that the addition of gelled powder additives comprising certain amounts of specially ground and gelled salts of weak acids which decompose when contacted with ignited surfaces when suspended in liquefied HFC gases used for fire extinguishing purposes, eliminate or reduce Hydrogen Fluoride.

14. The invention comprises a substantially non-aqueous, flame-extinguishing composition for extinguishing a fire at the sight of a potential flame comprising a fluorocarbon in admixture with a gelled powder additive comprising salts of weak acids which decompose at the temperature of the sight to reduce or eliminate HF released by the composition when used to extinguish flames.

15. The invention also comprises a method to reduce or eliminate HF released while extinguishing fires at the sight of a potential flame comprising by flooding or stream the compositions of the invention at the sight.

### DETAILED DESCRIPTION OF THE PREFERRED EMBODIMENTS OF THE INVENTION

16. Non-aqueous, flame-extinguishing agents are well-known in the art. This invention is directed to fluorocarbon agents. The inventive gelled additive is represented by salts of weak acids which decompose at temperatures obtained when contacted with ignited surfaces plurality of particles of a dry powder fire-extinguishing agent dispersed in a gel.

17. We have discovered that salts of weak acids that decompose when contacted with ignited surfaces reduce HF presence. This may be because the Fluorine binds with the salt or because the presence of these salts slows down the decomposition of the FC to HF.

18. Preferred dry powder fire-extinguishing agents are solid forms of the ammonium salts, sodium salts, and potassium salts. In more preferred embodiments the salt comprises sodium bicarbonate, potassium bicarbonate, lithium carbonate, ammonium bicarbonate, ammonium carbamate, mono-ammonium phosphate, di-ammonium phosphate, and ammonium polyphosphates. The ammonium polyphosphate and sodium bicarbonate solid particles are preferred dry chemical agents for practice of the present invention. However, it is understood that the preferred salts may be determined by the temperature of the fire being put out. For example the burning temperature of cotton is 180 C. while the burning temperature of various metals would be much higher.

19. The salt particles should be less than 50 microns and are preferably between 4 and 30 microns, more preferably less than 10 microns. The amount of the chemical agents should be between 2-55% of the admixture, depending on the additive used. In preferred embodiments, 15-20% of specially ground (to less than 10 microns ammonium polyphosphate (APP)) is gelled. In a second preferred embodiment, 3 to 7% specially ground and gelled sodium bicarbonate may be used. Each of these powders has its own particular merits such as classes of fires where it is most effective (for example, wood vs. gasoline).

20. Testing

21. The effects of the inventive composition on HF concentrations produced by the decomposition of HFC agents during fire extinguishment were measured by using a 3.625 inch diameter fire pan with 250 ml of heptane as a fuel source, inside a 1.5 cubic diameter Plexiglas enclosure. Varying amounts of the inventive composition were added to heptafluoroproane (FM-200) and hexafluoropropane (FE-36) to study the potential for the inventive composition to scavenge the HF acid gas produced by the decomposition of the FM-200 and FE-36.

22. Measurement of HF gas concentrations versus time provides a monitor of the fire history and of the effectiveness of any HF-controlling agent used. That is, the time from fire suppressant release until the maximum HF concentration occurs is a measure of the time required for fire extinguishment (also verified visually suing the video recorder). The rate at which the HF concentration decreases following extinguishment provides a measure of effectiveness of the controlling agent (when used) or a measure of the rate at which HF gas reacts with the walls of the enclosure. The decrease in the TDL HF levels for fires extinguished using the HFC gas compared to fires extinguished by the HFC gas plus 20-percent APP (approximately a factors of 22) is partially attributable to the fire suppression properties of APP (reflected by the shorter fire-out times).

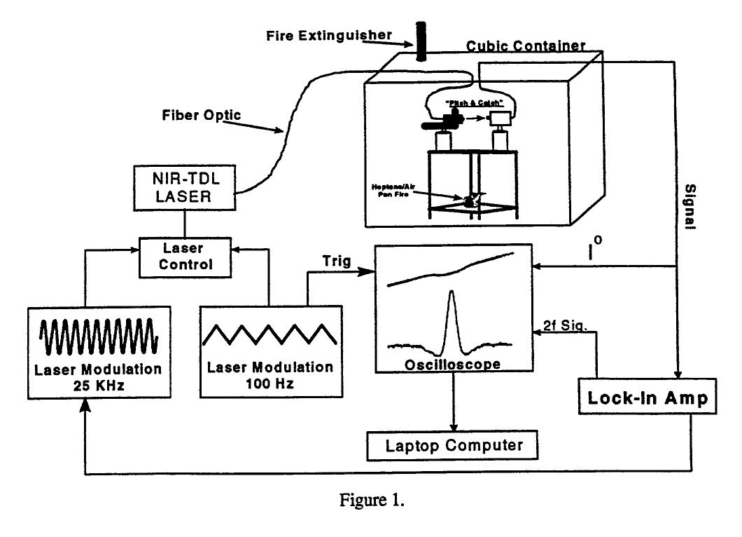

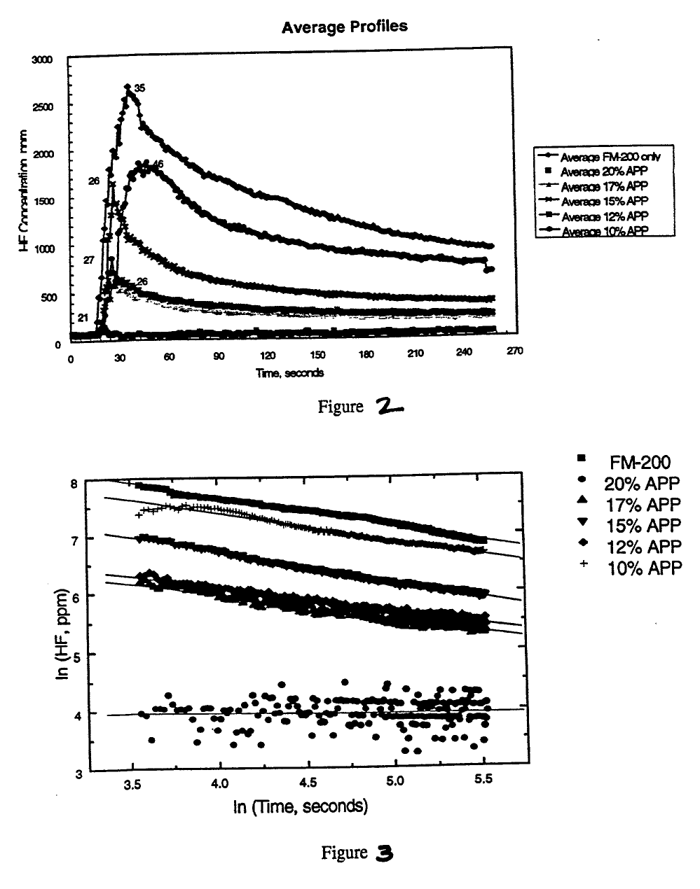

23. To evaluate the scavenging effects caused by APP, the time rate of change of the concentration was compared between extinguishers containing APP and extinguishers containing only FM-200. The rate of change in HF concentrations can be compared between extinguishers using data from FIG. 2 starting at the maximum HF concentration time (tₒ≈26 seconds) and plotting the natural logarithm of the HF concentration versus the natural logarithm of the elapsed time from the HF maximum, as seen in FIG. 3. The time rate of change can be defined as the change in HF concentration normalized to the corresponding change in time. The time rate of change is typically calculated by fitting experimental data to a straight line using linear regression analysis and determining the slope of the line. The slope is defined as the vertical distance (y-axis values) divided by the horizontal distance (x-axis values) between any two points along a straight line which is the rate of change along the line. Since the HF concentrations decrease as a function of time, the concentrations are dissipating. Thus, scavenging is implied if the slope value for data from an extinguisher with APP is greater than the slope value for data from fires extinguished by the HFC gas only. The time rate of change of HF concentrations is compared among the various extinguishers is shown in FIG. 3, using the slope values obtained from linear regression analysis of the post-fire HF concentrations measured with the TDL technique. These results indicate that the 15 percent plus APP extinguisher tests slightly increased the rate of HF dissipation, i.e., increased slope value, with respect to the HF dissipation rate for the fires extinguished only by the HFC gas.

24. The analysis indicates fires extinguished with only FM-200 produced unacceptably high HF levels, while all the varying degrees of the additive presence of APP reduced HF down to a lower level than the gases alone.

25. The presence of the tested APP shows a drastic reduction in the generation of HF and all the toxic and corrosive characteristics involved. There appears to be something in the presence of the APP that disrupts the ability of all HFC Halon replacements to generate Hydrogen Fluoride and Ammonium Fluoride. The reduction is clearly evident.

26. In addition to the reduction of HF, not just toxicity is reduced to acceptable levels but corrosion is also reduced.

27. The above tests demonstrated the ability of the inventive composition to reduce HF concentrations.

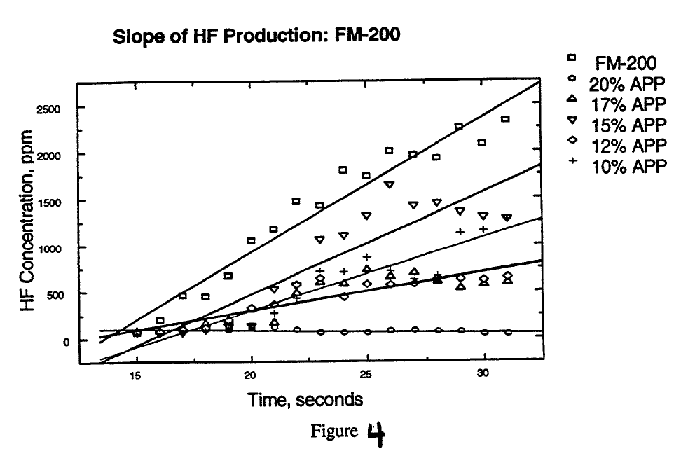

28. The presence of APP, regardless of the percentage in the extinguisher, helps reduce the overall HF levels with respect to those fires extinguished with FM-200 only in the enclosure. A possible explanation for the HF reductions is that the presence of the combination of APP and the HFC gas at the time of agent application slows the decomposition of FM-100 to HF. Thus, without APP in the enclosure, fires extinguished by the HFC gas alone are able to produce HF more rapidly than fires extinguished by the HFC gas plus APP as shown in FIG. 4.

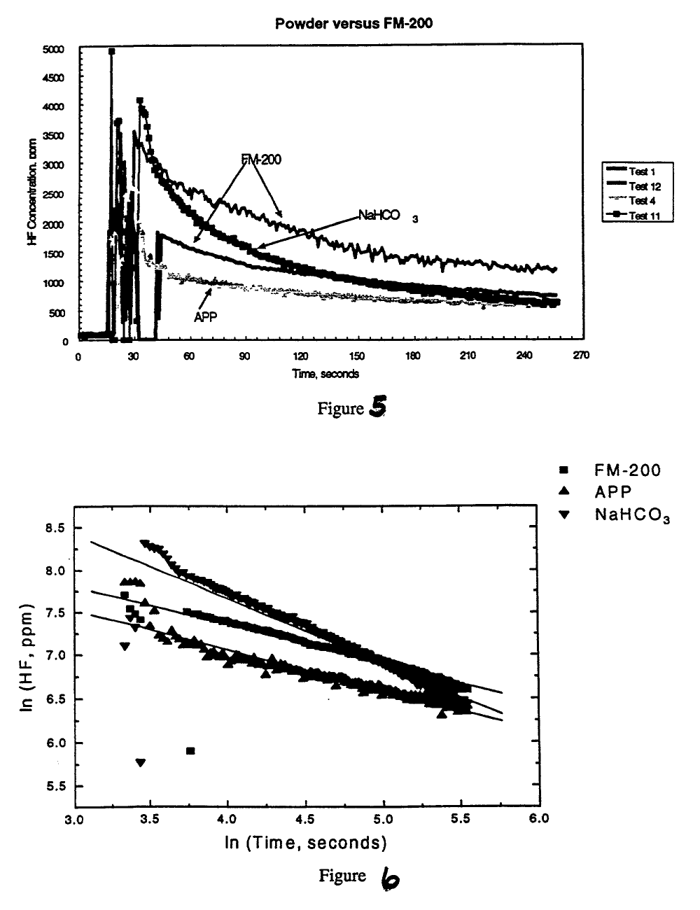

29. A separate experiment was conducted where NaHCO₃ was introduced into the chamber in a separate extinguisher. The intent was to eliminate the fire suppression capabilities of the agents in order to see if either powder reduced HF concentration faster than if no powder was present at all. The results from these tests are presented in FIGS. 5 and 6. The tests indicate that the presence of a powder helps to accelerate the dissipation of HF from the enclosure.

30. Thus by the present invention its advantages will be realized and although preferred embodiments have been disclosed and described in detail herein, its scope should not be limited thereby rather its scope should be determined by that of the appended claims.

What is claimed is:

1. A substantially non-aqueous, flame-extinguishing composition used to extinguish a fire comprising a fluorocarbon gas in admixture with a gelled powder additive, said additive comprising salts of weak acids which decompose at the temperature of the fire.

2. A composition according to claim 1 wherein the salt is selected from the group consisting of ammonium salts, sodium salts, and potassium salts.

3. A composition according to claim 1 wherein the salt is selected from the group consisting of sodium bicarbonate, potassium bicarbonate, lithium carbonate, ammonium bicarbonate, ammonium carbamate, mono-ammonium phosphate, di-ammonium phosphate, and ammonium polyphosphates.

4. A composition according to claim 1 wherein the salt is an ammonium polyphosphate.

5. A composition according to claim 1 wherein the salt is sodium bicarbonate.

6. A composition according to claim 1 wherein the salt particles are less than 50 microns.

7. A composition according to claim 1 wherein the salt particles are between 4 and 30 microns.

8. A composition according to claim 1 wherein the salt particles are less than 10 microns.

9. A composition according to claim 1 wherein the additive comprises between 2-55% of the admixture.

10. A composition according to claim 4 wherein the additive comprises 15-20% of the admixture.

11. A composition according to claim 10 wherein the salt particles are less than 10 microns.

12. A composition according to claim 5 wherein the additive comprises 3-7% of the admixture.

13. A composition according to claim 12 wherein the salt particles are less than 10 microns.
